(19) United States
(12) Patent Application Publication
(10) Pub. No.: US 2025/0278992 A1
(43) Pub. Date: Sep. 4, 2025

(54) THROW DETECTION USING LIDAR

(71) Applicant: The Indoor Lab, LLC, San Juan Capistrano, CA (US)

(72) Inventor: Patrick Blattner, Dana Point, CA (US)

(73) Assignee: The Indoor Lab, LLC, San Juan Capistrano, CA (US)

(21) Appl. No.: 19/065,487

(22) Filed: Feb. 27, 2025

Related U.S. Application Data
(60) Provisional application No. 63/559,293, filed on Feb. 29, 2024.

(51) Int. Cl. G08B 13/181; G01S 17/89; G08B 13/196; G08B 25/00

(52) U.S. Cl. CPC G08B 13/181; G01S 17/89; G08B 13/1963; G08B 13/19645; G08B 13/19652; G08B 13/19691; G08B 25/006

(57) ABSTRACT

The inventive throw detection system includes a plurality of lidars positioned to cover a predetermined security area, each lidar being wirelessly connected to a computer running a program to monitor the predetermined security area. The program detects when a person throws an object from an unsecured zone to a secured zone, and sends an alert to security.

### CROSS-REFERENCE TO RELATED APPLICATIONS

This application claims priority to provisional application No. 63/559,293, filed Feb. 29, 2024, the entire contents of which are incorporated by reference.

### BACKGROUND OF THE INVENTION

Areas with security, such as airports, train stations or any other public transportation security area, have problems with people from outside security throwing objects to another person inside security. An example could be a person before airport security throwing a gun over a divider to a person who has gone through security. What is needed is a system for dealing more efficiently with detecting thrown objects, such as guns, parts of guns, drugs, knives or other objects.

### SUMMARY OF THE INVENTION

Applicant can use lidars, positioned to view all public areas, and particularly security areas at airports, train stations or any other public transportation security area, to monitor and detect if a person throws an object, and particularly if a person throws an object from the unsecured side of security to the secured side.

Applicant's LiDAR-based security system introduces an AI-enhanced object tracking and threat detection platform for TSA checkpoints and other high-security environments. This real-time perception software has modules that detects thrown objects, identifies perpetrators and accomplices, and automatically integrates with surveillance and alert systems.

The thrown object detection & tracking module uses LiDAR point cloud data to detect anomalous hand and arm motions indicating an individual is throwing an object; tracks the thrown object's velocity, trajectory, and destination, ensuring continuous tracking until interception or landing, and identifies the receiver of the object and flags both individuals as potential security threats.

The perpetrator & accomplice identification module classifies individuals in the point cloud and color-codes perpetrators and accomplices for real-time security awareness; automatically locks onto the identified individuals, ensuring persistent tracking as they move through the security area, and integrates with existing video management systems (VMS) to switch surveillance cameras to focus on flagged individuals.

The automated surveillance & alerting system module generates instant alerts via SMS and email to TSA personnel, security teams, and law enforcement; provides real-time and replayable footage of the thrown object event using synchronized LiDAR and security camera feeds, and triggers AI-driven escalation protocols, notifying personnel based on the severity and risk level of the detected incident.

The AI-powered anomaly & threat detection module recognizes suspicious behaviors, such as coordinated movements between multiple individuals, abnormal body mechanics indicative of an attempted contraband throw, and unauthorized object transfers beyond designated security checkpoints. This module also enhances TSA and security personnel's response time through predictive analytics and automated tracking.

The key benefits the system provide are it prevents contraband smuggling in high-security zones; automates surveillance handoffs, ensuring uninterrupted tracking of threats; enhances real-time security response with AI-powered anomaly detection, and improves investigative capabilities with replayable incident reconstruction.

This cutting-edge LiDAR security platform transforms high-security screening environments, enhancing TSA efficiency and overall threat mitigation in airports, stadiums, mass transit hubs, and critical infrastructure facilities.

The inventive throw detection system includes a plurality of lidars positioned to cover a predetermined security area, each lidar being wirelessly connected to a computer running a program to monitor the predetermined security area. The program detects when a person throws an object from an unsecured zone to a secured zone, and sends an alert to security.

More specifically, the inventive system for detecting, tracking, and alerting security personnel of objects thrown within a LiDAR-generated point cloud environment, includes one or more LiDAR sensors generating a real-time three-dimensional (3D) point cloud representation of a security checkpoint area. The system also includes a classification algorithm configured to: (i) Identify human subjects as objects within the point cloud and track body mechanics; (ii) Detect arm motion characteristic of a throwing action by analyzing limb velocity, acceleration, and trajectory; (iii) Classify and isolate thrown objects within the point cloud and track their flight path through the air; and (iv) Detect object reception by identifying a secondary human subject receiving the object. The system also includes a real-time visualization module that dynamically alters the point cloud's colorization, wherein: (i) the throwing individual is colorized red upon detection of a throwing motion; (ii) The receiving accomplice is colorized with a specified alert color; and (iii) a visual tracer is applied to the thrown object, displaying its flight path across the point cloud environment. The system also includes d) an integration module that: (i) interfaces with Video Management Systems (VMS) to activate and direct security cameras to focus on the identified perpetrator; (ii) synchronizes camera tracking with telemetry data from the classified object ID of the throwing individual, and (iii) generates and transmits instant security alerts, including: an SMS or email notification to TSA personnel with real-time alert details, and a video replay file showing the detected throw, the object's airborne trajectory, and the accomplice's reception. The system provides a continuous tracking engine that ensures camera systems remain locked onto the identified perpetrators as they move throughout the security checkpoint.

The body mechanics analysis uses a LiDAR-driven skeletal tracking model to distinguish between normal arm movement and a throwing action. The thrown objects are classified based on velocity, size, shape, and airborne trajectory characteristics. The real-time alerts include a timestamped visual log correlating the LiDAR-detected throw event with synchronized camera footage. The thrown objects are assigned a unique object ID, allowing for continuous tracking even if intercepted or dropped. The integration with security cameras enables auto-zooming and object-based motion tracking based on LiDAR telemetry data. Multiple LiDAR sensors work in unison to expand detection coverage across wide-open TSA security spaces. The system further includes a machine-learning model trained on historical LiDAR motion data to improve accuracy in detecting throwing motions and object trajectories. Airport security command centers receive real-time dashboards displaying LiDAR-enhanced event replays alongside live security camera feeds. LiDAR-based alerts integrate with airport access control systems to trigger lockdowns or direct security personnel to interception points.

Another embodiment of the system for AI-enhanced threat detection using LiDAR-based point cloud analysis, includes a) a machine-learning algorithm trained on historical LiDAR motion data to identify suspicious behaviors, including: (i) Unusual body mechanics such as rapid crouching, erratic movements, or concealed hand motions indicative of contraband handling; (ii) Coordinated movements between multiple individuals suggesting illicit object transfers or collusion; (iii) High-velocity object motion inconsistent with normal passenger behavior, triggering a security alert. A risk scoring engine assigns threat levels to detected behaviors based on predefined security parameters. The system also provides automated real-time visual tracking, wherein individuals exhibiting high-risk behavior are: (i) color-coded within the point cloud based on their assigned threat level; (ii) tagged with an alert icon visible on security dashboards; and (iii) tracked across multiple camera angles via integration with video management systems (VMS).

The AI models analyze movement velocity, gait irregularities, and micro-expressions to detect hidden threats such as weapons or concealed items. The AI continuously learns from real-world security incidents to refine its threat detection accuracy. The system further includes a geofencing module that detects individuals lingering near restricted zones or security bypass routes.

The AI system distinguishes between normal and abnormal object interactions, such as: a) a person intentionally dropping an item for an accomplice versus accidentally dropping personal belongings; b) objects being discreetly passed between individuals versus natural hand gestures; and c) sudden changes in movement patterns following a detected object transfer.

The system includes an AI-powered anomaly detection module that a) flags individuals exhibiting deceptive behavior, such as attempting to bypass security checkpoints without proper screening; b) integrates with airport access control systems to issue real-time alerts to security personnel for potential interventions, and c) uses LiDAR heatmaps to detect unexpected congestion or unauthorized gatherings near security checkpoints.

The system further includes an AI-assisted incident reconstruction tool that: a) replays security events using synchronized LiDAR and video footage, highlighting suspicious activities in an interactive dashboard; b) uses predictive modeling to determine potential future security risks based on historical threat data; and c) generates automated security reports detailing threat events, response times, and system accuracy metrics.

Finally, the system detected threat events trigger an automatic escalation protocol, such that: a) AI assesses the severity of the threat and determines whether to notify local TSA agents, airport police, or federal security agencies; b) real-time alerts are distributed through SMS, email, or push notifications to designated personnel; and c) LiDAR-tracked individuals are locked into an incident tracking system, allowing continuous surveillance until the security threat is neutralized.

### BRIEF DESCRIPTION OF DRAWINGS

FIG. 1 shows a block diagram of the throw detection using lidar system.

FIGS. 2(a)-2(g) show seven different environments in which the system can be utilized.

FIG. 3(a)-(b) shows two views showing how bodies show up in LiDAR.

FIG. 4 shows a LiDAR view of an object being thrown.

FIG. 5 shows a LiDAR view of a thrown object with landing location.

FIG. 6 shows a LiDAR view of a perpetrator, the trajectory of a thrown object and a receiver.

FIG. 7 shows a LiDAR perspective view of a throw example from a landside overflow area to triple escalator.

FIG. 8 shows a photographic view of FIG. 7.

FIG. 9(a)-(b) shows a schematic view of the throw zone and target zone, and (b) shows a perspective view showing the location of the four LiDAR sensors.

FIG. 10(a)-(b) shows a perspective view and (b) shows a schematic view showing the six floor zones, the fifth floor zones, the target zones and several different alerts.

FIG. 11(a)-(b) shows a photo view of a single person bag leave behind, and (b) shows a LiDAR view of the same.

FIG. 12(a)-(b) shows a photo view of a crowd bag leave behind, and (b) shows a LiDAR view of the same.

FIG. 13 shows another view of a triple escalator showing throw tracers and throw plots.

FIG. 14 shows the perpetrator and receiver color coded in red and blue at 62.

### DETAILED DESCRIPTION OF THE INVENTION

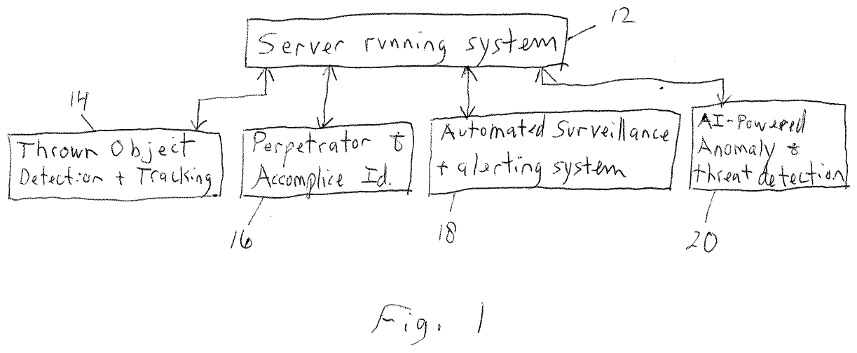

FIG. 1 shows a block diagram of the throw detection using lidar system, which is running in a server, shown at 12. The system includes a set of modules including a thrown object detection and tracking module, shown at 14; a perpetrator and accomplice identification module, shown at 16, an automated surveillance and alerting system module, shown at 18 and an AI-powered anomaly and threat detection module, shown at 20.

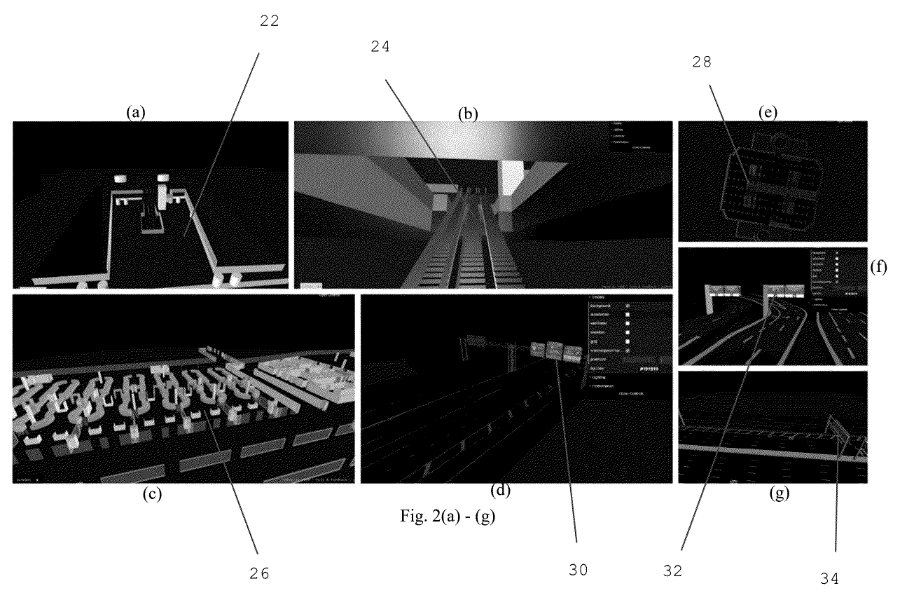

FIGS. 2(a)-2(g) show seven different environments in which the system can be utilized. Each of the views are LiDAR perspective views with 22 being an airport great hall; 24 showing a triple escalator; 26 showing airport security; 28 showing a parking level, and 30, 32 and 34 showing different sections of highway.

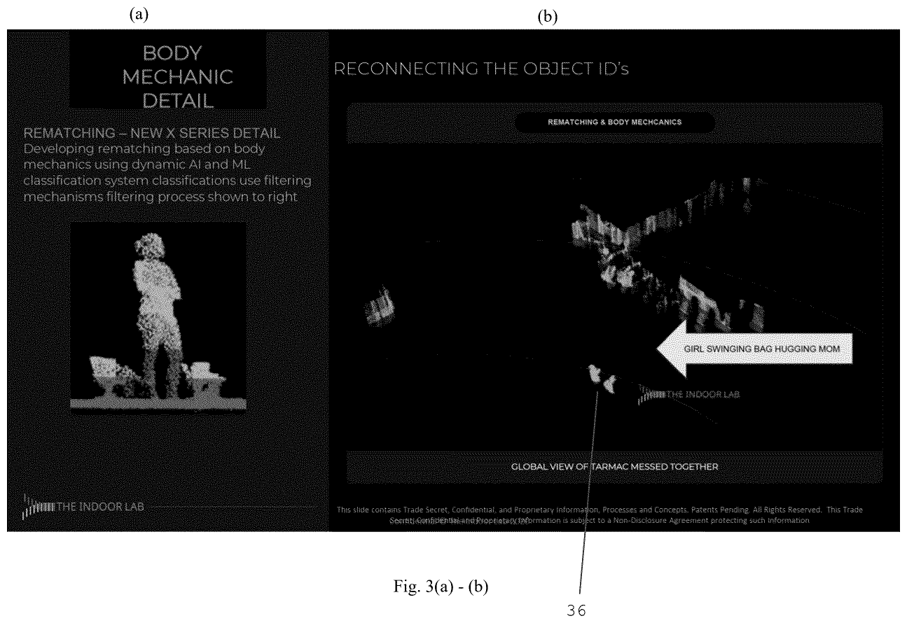

FIG. 3(a)-(b) shows two views showing how bodies show up in LiDAR. 3(a) shows body mechanic detail which is used to reconnect objects to object ID's based on body mechanics, using dynamic AI and ML (artificial intelligence and machine learning) classification system classifications. 3(b) shows a view of a girl swinging a bag and hugging her mother, shown at 36.

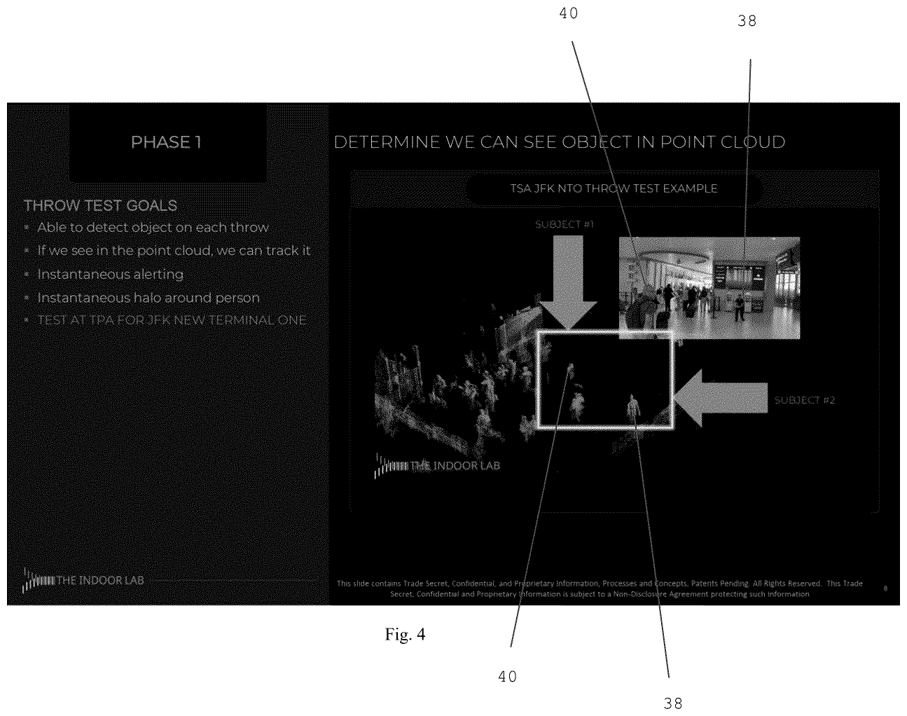

FIG. 4 shows a test throw example, showing subject #1, subject #2 and the detected thrown object. Subject #1 is shown in both the photo view and the LiDAR view at 38, and subject #2 at 40. The system first determines if it can see the object in the point cloud (phase 1).

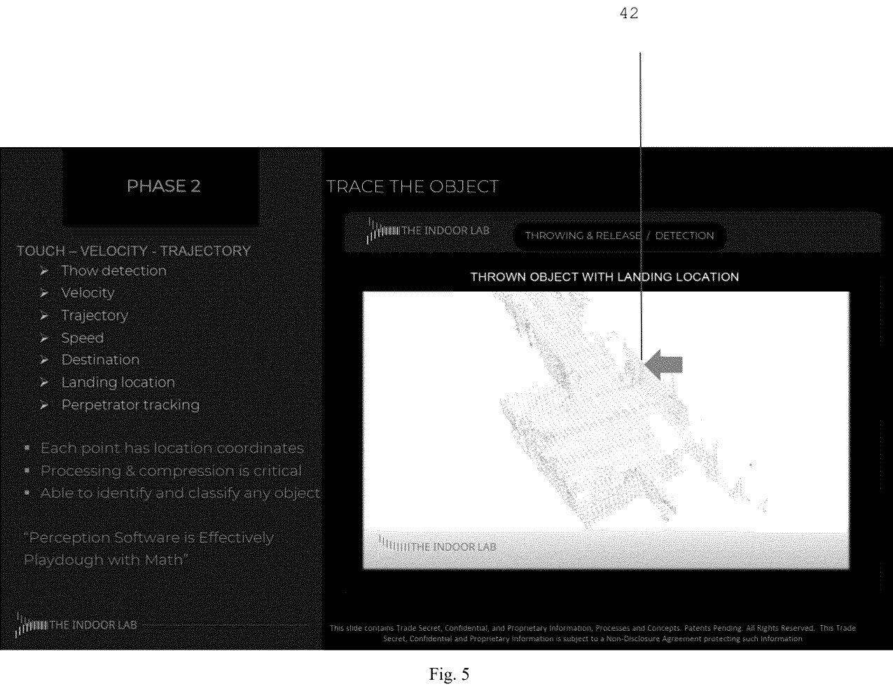

FIG. 5 shows a LiDAR view of a thrown object with landing location, shown at 42. The software can detect the thrown object, its velocity, its trajectory, its speed its destination and landing location and track the perpetrator. The system next traces the object (phase 2).

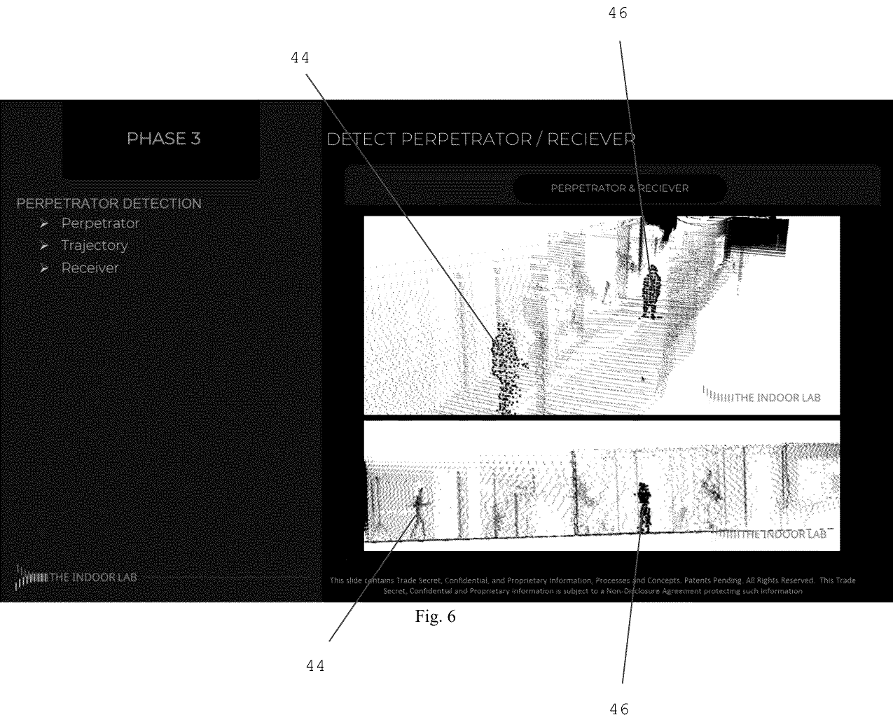

FIG. 6 shows a LiDAR view of a perpetrator, the trajectory of a thrown object and a receiver. The figure shows several views of the perpetrator (person throwing), the trajectory of the thrown object and the receiver (person receiving object). Finally, the system detects the perpetrator and the receiver (phase 3). The perpetrator (thrower) is shown at 44 in two different perspective views and the receiver is shown at 46. In FIGS. 4-6 the thrower is shown just about to throw the object.

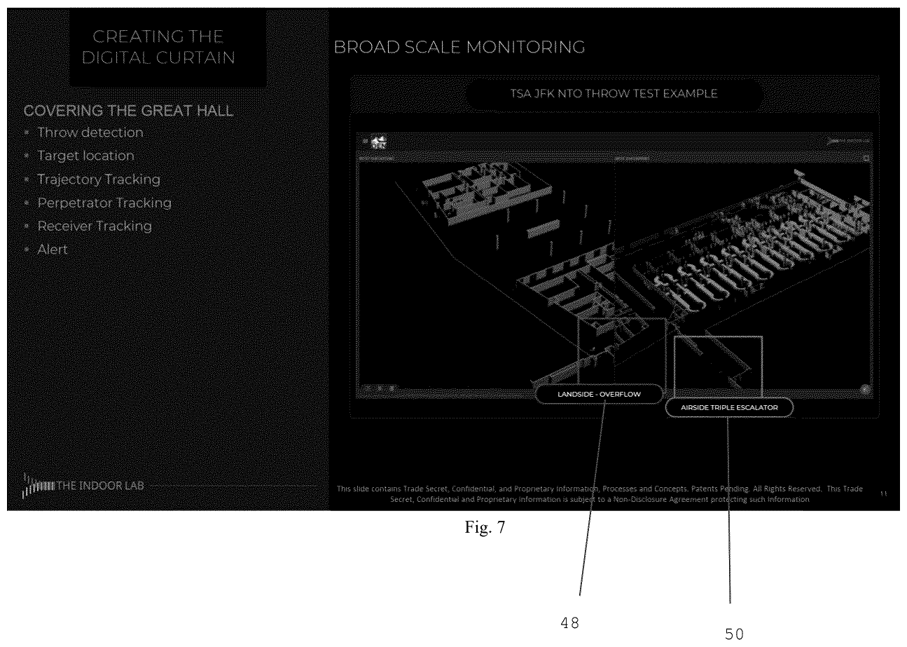

FIG. 7 shows a LiDAR perspective view of a throw example from a landside overflow area to triple escalator. The throw area is shown in red at 48 and the receiver area is shown in green at 50.

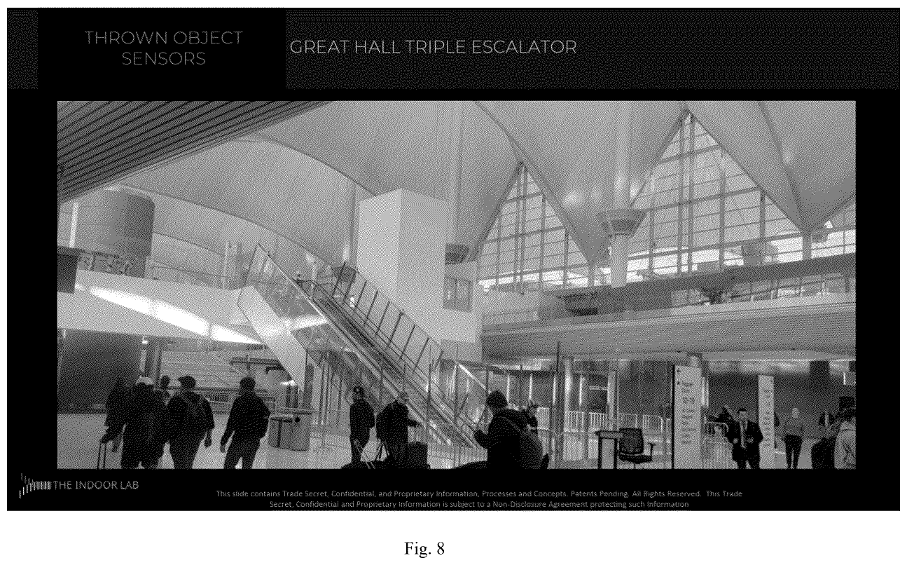

FIG. 8 shows a photographic view of the triple escalator of FIG. 7.

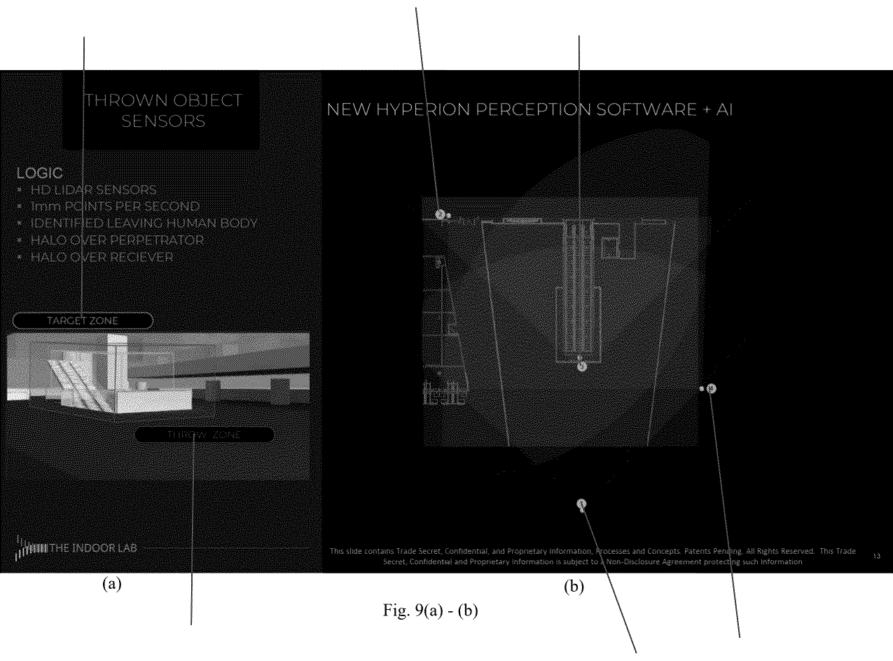

FIG. 9 (a)-(b) shows a schematic view of the throw zone and target zone, and (b) shows a perspective view showing the location of the four LiDAR sensors.

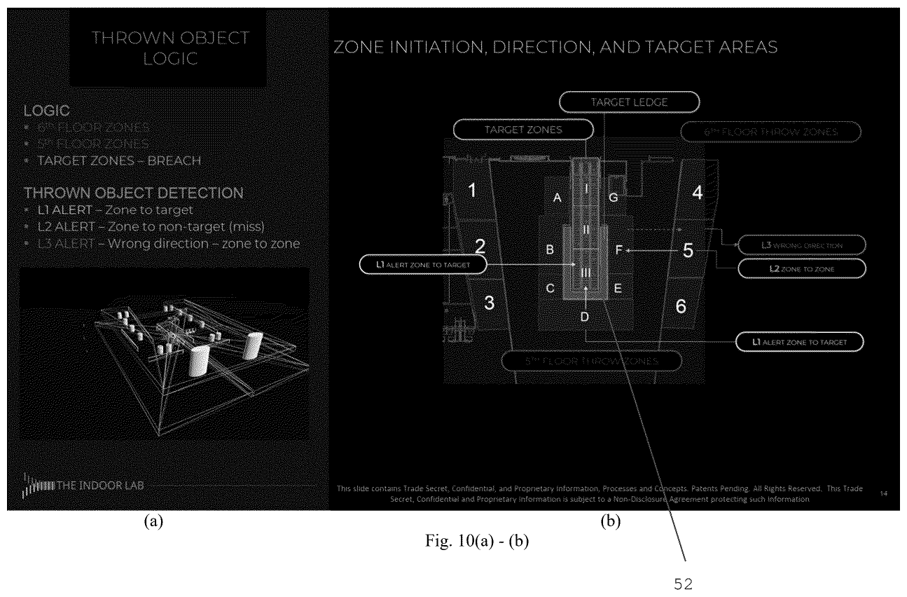

FIG. 10(a)-(b) shows a perspective view and (b) shows a schematic view showing the six floor zones, the fifth floor zones, the target zones and several different alerts. The color coding shows the place where the throw occurs, the direction of throw and the place where the throw is going to land. The alerts are classified L1 (zone to target—yellow); L2 (zone to non-target (miss)—orange), and L3 (wrong direction zone to zone)—green. The fifth floor zones are shown in purple and numbered A-G. The sixth floor zones are shown in red and numbered 1-6. The target zones are shown in blue and numbered I, II and III. Finally, the target ledge is shown at 52

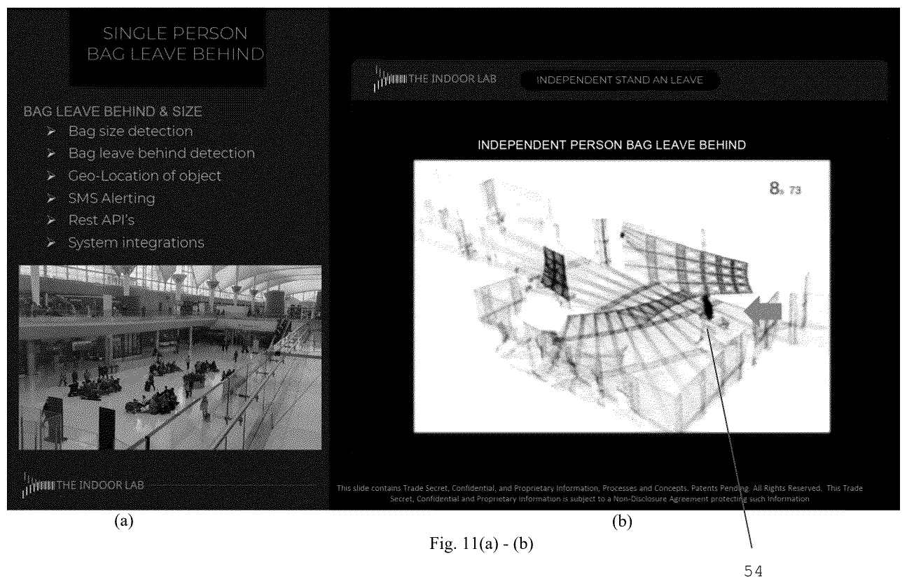

FIG. 11(a)-(b) shows a photo view of an airport area, and (b) shows a LiDAR view of a single person leaving a bag behind. The software detects the bag size, that it is being left behind, the geo-location of the object being left behind, and sends an SMS alert. The person leaving the bag behind is shown at 54.

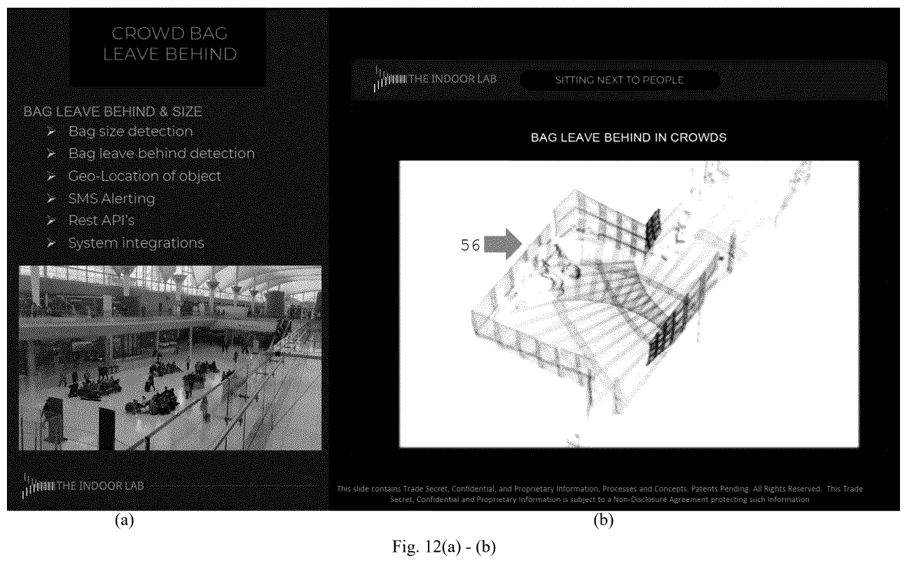

FIG. 12(a)-(b) shows a photo view of an airport area, and (b) shows a LiDAR view of a crowd of people leaving their bags behind, at 56. The software detects the bag size, that it is being left behind, the geo-location of the object(s) being left behind, and sends an SMS alert.

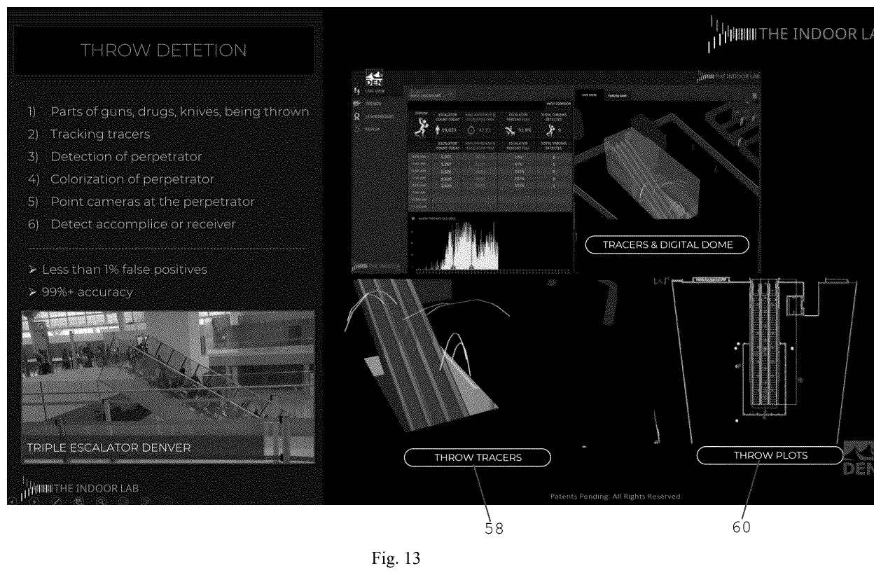

FIG. 13 shows another view of the triple elevator showing throw tracers and throw plots, shown at 58 and 60.

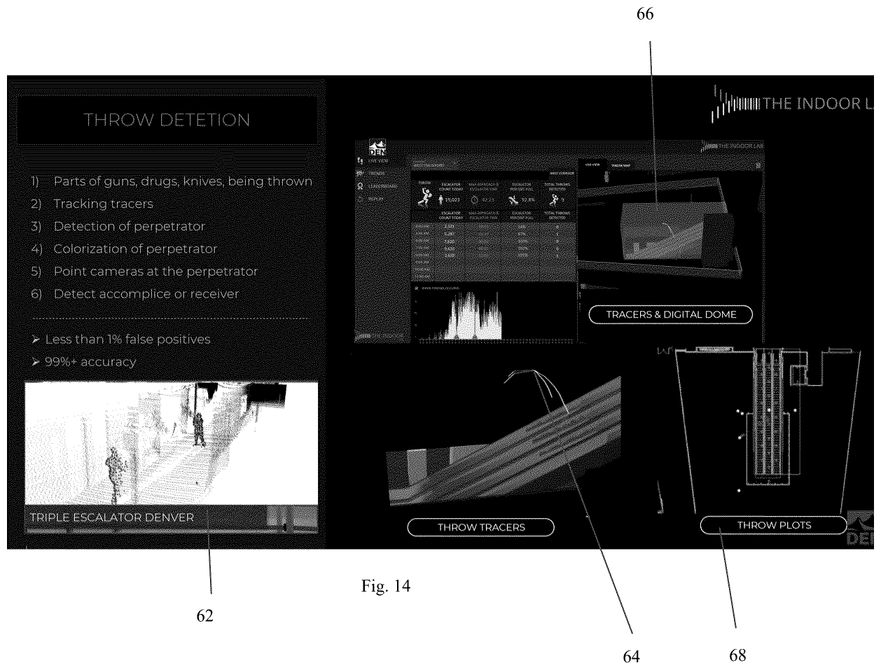

FIG. 14 shows the perpetrator and receiver color coded in red and blue at 62. In the image on the left at 62, the colors are shown. The image on the right shows the tracers on detecting the object, at 64. The dome also turned red in the interface at 66, and the plot diagram on the lower right shows the plot of the thrower and the receive and where the throw occurred, at 68.

1. A throw detection system comprising:
a plurality of lidars positioned to cover a predetermined security area, each lidar being wirelessly connected to a computer running a program to monitor the predetermined security area;
the program detects when a person throws an object from an unsecured zone to a secured zone, and sends an alert to security.

2. A system for detecting, tracking, and alerting security personnel of objects thrown within a LiDAR-generated point cloud environment, comprising:
a) One or more LiDAR sensors generating a real-time three-dimensional (3D) point cloud representation of a security checkpoint area;
b) A classification algorithm configured to:
(i) Identify human subjects as objects within the point cloud and track body mechanics;
(ii) Detect arm motion characteristic of a throwing action by analyzing limb velocity, acceleration, and trajectory;
(iii) Classify and isolate thrown objects within the point cloud and track their flight path through the air; and
(iv) Detect object reception by identifying a secondary human subject receiving the object;
c) A real-time visualization module that dynamically alters the point cloud's colorization, wherein:
(i) The throwing individual is colorized red upon detection of a throwing motion;
(ii) The receiving accomplice is colorized with a specified alert color; and
(iii) A visual tracer is applied to the thrown object, displaying its flight path across the point cloud environment;
d) An integration module that:
(i) Interfaces with Video Management Systems (VMS) to activate and direct security cameras to focus on the identified perpetrator;
(ii) Synchronizes camera tracking with telemetry data from the classified object ID of the throwing individual;
(iii) Generates and transmits instant security alerts, including:
An SMS or email notification to TSA personnel with real-time alert details;
A video replay file showing the detected throw, the object's airborne trajectory, and the accomplice's reception;
e) A continuous tracking engine that ensures camera systems remain locked onto the identified perpetrators as they move throughout the security checkpoint.

3. The system of claim 2, wherein body mechanics analysis uses a LiDAR-driven skeletal tracking model to distinguish between normal arm movement and a throwing action.

4. The system of claim 2, wherein thrown objects are classified based on velocity, size, shape, and airborne trajectory characteristics.

5. The system of claim 2, wherein real-time alerts include a timestamped visual log correlating the LiDAR-detected throw event with synchronized camera footage.

6. The system of claim 2, wherein thrown objects are assigned a unique object ID, allowing for continuous tracking even if intercepted or dropped.

7. The system of claim 2, wherein the integration with security cameras enables auto-zooming and object-based motion tracking based on LiDAR telemetry data.

8. The system of claim 2, wherein multiple LiDAR sensors work in unison to expand detection coverage across wide-open TSA security spaces.

9. The system of claim 2, further comprising a machine-learning model trained on historical LiDAR motion data to improve accuracy in detecting throwing motions and object trajectories.

10. The system of claim 2, wherein airport security command centers receive real-time dashboards displaying LiDAR-enhanced event replays alongside live security camera feeds.

11. The system of claim 2, wherein LiDAR-based alerts integrate with airport access control systems to trigger lockdowns or direct security personnel to interception points.

12. A system for AI-enhanced threat detection using LiDAR-based point cloud analysis, comprising:
a) A machine-learning algorithm trained on historical LiDAR motion data to identify suspicious behaviors, including:
(i) Unusual body mechanics such as rapid crouching, erratic movements, or concealed hand motions indicative of contraband handling;
(ii) Coordinated movements between multiple individuals suggesting illicit object transfers or collusion;
(iii) High-velocity object motion inconsistent with normal passenger behavior, triggering a security alert;
b) A risk scoring engine that assigns threat levels to detected behaviors based on predefined security parameters;
c) Automated real-time visual tracking, wherein individuals exhibiting high-risk behavior are:
(i) Color-coded within the point cloud based on their assigned threat level;
(ii) Tagged with an alert icon visible on security dashboards; and
(iii) Tracked across multiple camera angles via integration with video management systems (VMS).

13. The system of claim 12, wherein AI models analyze movement velocity, gait irregularities, and micro-expressions to detect hidden threats such as weapons or concealed items.

14. The system of claim 12, wherein AI continuously learns from real-world security incidents to refine its threat detection accuracy.

15. The system of claim 12, further comprising a geofencing module that detects individuals lingering near restricted zones or security bypass routes.

16. The system of claim 12, wherein the AI system distinguishes between normal and abnormal object interactions, such as:
a) A person intentionally dropping an item for an accomplice versus accidentally dropping personal belongings;
b) Objects being discreetly passed between individuals versus natural hand gestures; and
c) Sudden changes in movement patterns following a detected object transfer.

17. The system of claim 12, wherein an AI-powered anomaly detection module:
a) Flags individuals exhibiting deceptive behavior, such as attempting to bypass security checkpoints without proper screening;
b) Integrates with airport access control systems to issue real-time alerts to security personnel for potential interventions;
c) Uses LiDAR heatmaps to detect unexpected congestion or unauthorized gatherings near security checkpoints.

18. The system of claim 12, further comprising an AI-assisted incident reconstruction tool that:
a) Replays security events using synchronized LiDAR and video footage, highlighting suspicious activities in an interactive dashboard;
b) Uses predictive modeling to determine potential future security risks based on historical threat data; and
c) Generates automated security reports detailing threat events, response times, and system accuracy metrics.

19. The system of claim 12, wherein detected threat events trigger an automatic escalation protocol, such that:
a) AI assesses the severity of the threat and determines whether to notify local TSA agents, airport police, or federal security agencies;
b) Real-time alerts are distributed through SMS, email, or push notifications to designated personnel; and
c) LiDAR-tracked individuals are locked into an incident tracking system, allowing continuous surveillance until the security threat is neutralized.
